(19) United States
(12) Patent Application Publication
(10) Pub. No.: US 2025/0278483 A1
(43) Pub. Date: Sep. 4, 2025

(54) DEVICES, SYSTEMS, AND METHODS FOR INGESTING & ENRICHING SECURITY INFORMATION TO AUTONOMOUSLY SECURE A PLURALITY OF TENANT NETWORKS

(71) Applicant: BlueVoyant LLC, New York, NY (US)

(72) Inventor: Neel Arora, New York, NY (US)

(73) Assignee: BlueVoyant LLC, New York, NY (US)

(21) Appl. No.: 18/858,926

(22) PCT Filed: May 19, 2023
(86) PCT No.: PCT/US2023/022858

§ 371 Date: Oct. 22, 2024

Related U.S. Application Data
(60) Provisional application No. 63/344,305, filed on May 20, 2022.

(51) Int. Cl. G06F 21/55; G06F 21/56

(52) U.S. Cl. CPC G06F 21/554; G06F 21/566

(57) ABSTRACT

A Security Information and Event Management (“SIEM”) provider server configured to enhance network security on behalf of a tenant network by autonomously ingesting and enriching security information associated with the tenant network is disclosed herein. The SIEM provider server can be configured to periodically monitor the tenant network for configuration changes, detect a configuration change in the tenant network, update a fetch job parameter stored in a job database based on the detected configuration change in the tenant network, generate a fetch job for the tenant network based on the updated job parameter stored in the job database and store the generated fetch job in a queue, execute the generated fetch job such that the job manager retrieves security information from a data source associated with the tenant network, enrich the retrieved security information, and generate an output configured to enhance the security of the tenant network.

### CROSS-REFERENCE TO RELATED APPLICATIONS

The present application is related to U.S. Provisional Patent Application No. 63/344,305, titled DEVICES, SYSTEMS, AND METHODS FOR INGESTING & ENRICHING SECURITY INFORMATION TO AUTONOMOUSLY SECURE A PLURALITY OF TENANT NETWORKS, filed May 20, 2022, the disclosure of which is incorporated by reference in its entirety herein.

### FIELD

The present disclosure is generally related to network security, and, more particularly, is directed to improved devices, systems, and methods for issuing Security Information and Event Management (SIEM) client updates.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a Security Information and Event Management (“SIEM”) provider server is disclosed. The SIEM provider server can be configured to enhance network security on behalf of a tenant network by autonomously ingesting and enriching security information associated with the tenant network. The SIEM provider server can include a processor and a memory configured to store a job manager and a workflow engine that, when executed by the processor, cause the processor to: periodically monitor the tenant network for configuration changes, detect a configuration change in the tenant network, update a fetch job parameter stored in a job database based on the detected configuration change in the tenant network, generate a fetch job for the tenant network based on the updated job parameter stored in the job database and store the generated fetch job in a queue, execute the generated fetch job such that the job manager retrieves security information from a data source associated with the tenant network, enrich the retrieved security information, and generate an output configured to enhance the security of the tenant network.

In various aspects, a method of enhancing network security on behalf of a tenant network is disclosed. The method can include autonomously ingesting and enriching security information associated with the tenant network via a Security Information and Event Management (“SIEM”) provider server, wherein the SIEM provider server includes a processor and a memory configured to store a job manager and a workflow engine. The method can further include periodically monitoring the tenant network for configuration changes, detecting a configuration change in the tenant network, updating a fetch job parameter stored in a job database based on the detected configuration change in the tenant network, generating a fetch job for the tenant network based on the updated job parameter stored in the job database and store the generated fetch job in a queue, executing the generated fetch job such that the job manager retrieves security information from a data source associated with the tenant network, enriching the retrieved security information, and generating an output configured to enhance the security of the tenant network.

In various aspects, a system including a plurality of tenant networks, and a Security Information and Event Management (“SIEM”) provider server communicably coupled to the plurality of tenant networks is disclosed. The SIEM provider server can include a processor and a memory configured to store a job manager and a workflow engine that, when executed by the processor, cause the processor to periodically monitor the plurality of tenant networks for configuration changes, detect a configuration change in a first tenant network of the plurality of tenant networks, update a fetch job parameter stored in a job database based on the detected configuration change in the first tenant network, generate a fetch job for the tenant network based on the updated fetch job parameter stored in the job database and store the generated fetch job in a queue, execute the generated fetch job such that the job manager retrieves security information from a data source associated with the tenant network, enrich the retrieved security information, and generate an output configured to enhance the security of the tenant network.

These, and other objects, features, and characteristics of the present invention, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the invention.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates a diagram of a system configured to standardize and streamline the deployment of security information and event management artifacts for multiple tenants, in accordance with at least one non-limiting aspect of the present disclosure;

FIG. 2 illustrates a block diagram of a functional architecture of the system of FIG. 1, in accordance with at least one non-limiting aspect of the present disclosure;

FIG. 3 illustrates a block diagram of a deployment architecture employed by the system of FIG. 1, in accordance with at least one non-limiting aspect of the present disclosure;

FIG. 4 illustrates a platform configured to ingest and enrich a highly scalable quantity of security information via automation, in accordance with at least one non-limiting aspect of the present disclosure;

FIG. 5 illustrates a logic flow diagram of a method of ingesting and enriching security information to autonomously secure a plurality of tenant networks using the platform of FIG. 4, in accordance with at least one non-limiting aspect of the present disclosure;

FIG. 6 illustrates a framework for the job manager of the platform of FIG. 4, in accordance with at least one non-limiting aspect of the present disclosure;

FIG. 7 illustrates a method of ingesting and enriching a highly scalable quantity of security information, in accordance with at least one non-limiting aspect of the present disclosure; and

FIG. 8 illustrates a scalable security information and event management framework, in in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

The Applicant of the present application owns the following U.S. Provisional Patent Applications, the disclosure of each of which is herein incorporated by reference in its entirety:
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 202;
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022
International Patent Application No. PCT/US2022/072739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022;
International Patent Application No. PCT/US2022/072743, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 3, 2022;
U.S. Provisional Patent Application No. 63/365,819 titled DEVICES, METHODS, AND SYSTEMS FOR GENERATING A HIGHLY-SCALABLE, EFFICIENT COMPOSITE RECORD INDEX, filed on Jun. 3, 2022
U.S. Provisional Patent Application No. 63/353,992 titled DEVICES, SYSTEMS, AND METHODS FOR CATEGORIZING, PRIORITIZING, AND MITIGATING CYBER SECURITY RISKS, filed on Jun. 21, 2022;
U.S. Provisional Patent Application No. 63/366,903 titled DEVICES, SYSTEMS, AND METHOD FOR GENERATING AND USING A QUERYABLE INDEX IN A CYBER DATA MODEL TO ENHANCE NETWORK SECURITY, filed on Jun. 23, 2022;
U.S. Provisional Patent Application No. 63/368,567 titled DEVICES, SYSTEMS, AND METHODS FOR UTILIZING A NETWORKED, COMPUTER-ASSISTED, THREAT HUNTING PLATFORM TO ENHANCE NETWORK SECURITY, filed on Jul. 15, 2022;
U.S. Provisional Patent Application No. 63/369,582 titled AUTONOMOUS THREAT SCORING AND SECURITY ENHANCEMENT, filed on Jul. 27, 2022;
U.S. Provisional Patent Application No. 63/377,304, titled DEVICES, SYSTEMS, AND METHODS FOR CONTINUOUSLY ENHANCING THE IMPLEMENTATION OF CODE CHANGES VIA ENRICHED PIPELINES, filed on Sep. 27, 2022;
International Patent Application No. PCT/US2022/082167 titled DEVICES, SYSTEMS, AND METHODS FOR PROVISIONING AND UPDATING SECURITY INFORMATION & EVENT MANAGEMENT ARTIFACTS FOR MULTIPLE TENANTS, filed on Dec. 21, 2022;
International Patent Application No. PCT/US2022/082173 titled DEVICES, SYSTEMS, AND METHODS FOR STREAMLINING AND STANDARDIZING THE INGEST OF SECURITY DATA ACROSS MULTIPLE TENANTS, filed on Dec. 21, 2022;
International Patent Application No. PCT/US2023/061069 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 23, 2023;
International Patent Application No. PCT/US2023/062894, titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 20, 2023.

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative.

Before explaining various aspects of the systems, and methods disclosed herein in detail, it should be noted that the illustrative aspects are not limited in application or use to the details of disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, software suite, application, or development platform disclosed herein is merely intended to illustrate several of the many aspects of the present disclosure. This includes any, and all references to trademarks. Accordingly, it shall be appreciated that the devices, systems, and methods disclosed herein can be implemented to enhance any software update, in accordance with any intended use, and/or user preference.

As used herein, the term “server” may refer to or include one or more computing devices that are operated by or facilitate communication, and processing for multiple parties in a network environment, such as the Internet or any public or private network. Reference to “a server” or “a processor,” as used herein, may refer to a previously-recited server, and/or processor that is recited as performing a previous step or function, a different server, and/or processor, and/or a combination of servers, and/or processors.

As used herein, the term “tenant” may refer to one or more client organizations managed by a managed security service provider (“MSSP”). Tenants can include one or more servers configured to manage a network, such as an intranet, by which numerous client instances are connected. For example, a “client” or “client instance,” as used herein, can include a computing device (e.g., a laptop, a desktop computer, a mobile phone, etc.) that is connected to the tenant's network. According to some non-limiting aspects, a “client” or “client instance” can be a software agent, or a computing device external to the tenant's network that is connected via a virtual private network (“VPN”) connection.

As used herein, the term “constant” may refer to one or more SIEM functions that remain unchanged during the issuance of an alert. For example, a constant can include an Azure Sentinel Log Analytics function, amongst others. According to some non-limiting aspects, a constant can be specifically configured in accordance with an individual client's preferences and/or requirements. For example, alert rules, as described herein, can be the same for all client deployments. However, the apparatuses, systems, and methods disclosed herein can employ client-specific constants to “fine tune” how alerts are managed for each particular client. In other words, each constant can include a whitelist of specific protocols, accounts, etc. which the alert rule manages those constants differently (e.g., skips them).

As used herein, the term “enrichment” can include any process enhancing or adding to an initial input (e.g., data, a file, a piece of code, etc.) that is collected through ingestion. For example, the enrichment process can include, using the initial input to identify additional, relevant information from the same or alternate sources. According to other non-limiting aspects, enrichment can include a correlation, wherein relationships are identified between the input and an existing artifact (e.g., data, a file, a piece of code, etc.).

An example of above would be an EDR alert, the basic alert does not have more information so we ask the origin source for more information on the alert, if in that data a specific IP or domain is present we may go to a 3rd party or internal source to get more information like a reputation score.

Security Information and Event Management (“SIEM”) includes software configured to aggregate and analyze activity from many different resources across an entire information technology (IT) infrastructure. SIEM can be implemented to aggregate data from multiple systems, and analyze that data to catch abnormal behavior or potential cyberattacks. For example, SIEM may collect security data from network devices, servers, domain controllers, and more. SIEM can be implemented to store, normalize, aggregate, and apply analytics to that data to discover trends, detect threats, and enable organizations to investigate any alerts. Although known SIEM tools offer impressive functionality, including the ability to monitor events, collect data, and issue security alerts across a network, such tools are typically tailored for an implementing organization, and—more specifically—a particular network architecture, which can oftentimes be complex and/or customized for the particular organization.

One example of SIEM is Azure Sentinel, a popular, cloud-based tool. However, deploying Azure Sentinel requires a high level of skill, and, at the same time, it could be very time consuming, and error prone. Each organization that needs a security solution has special needs around monitoring, alerting, data ingestion, the detection/alert rules, the response automation, reporting, etc. Although Microsoft is often used by security services providers (“MSSP”) to manage multiple clients, the complexity of the initial configuration, deployment, and ongoing maintenance of artifacts (e.g., resource groups, log analytics workspaces, alert rules, workbooks, playbooks, etc.), has been increasing significantly. This can result in a high cost for both the MSSP—who must hire more expensive specialists—and for the client, who often bears at least a portion of the increasing expenses. However, there is often an overlap between some of the deployment needs of varying clients. For example, many organizations may require similar firewall monitoring solutions. In such instances, asset reuse, and re-deployment (and update) may lead to major cost reduction, and simplicity of operations. Unfortunately, known SIEM tools are technologically incapable of taking advantage of such synergies. Thus, from the initial provisioning, and throughout the automation of incident responses, MSSPs are left with limited re-use opportunities and cannot capture efficiencies across multiple clients.

An MSSP provides outsourced monitoring and management of security devices and systems on behalf of organizational clients. For example, an MSSP may provide clients with common services, including a managed firewall, intrusion detection, virtual private network, vulnerability scanning, and anti-viral services. An emerging trend in the MSSP industry is to develop technologies that are effectively three to five years ahead of what is available to the open market. For example, some proprietary SIEM technologies were developed when it became apparent that MSSP's could not purchase what they required off-the-shelf. Following the development of proprietary SIEM technologies, MSSPs then developed platforms for automating the management of SIEM platforms for their clients in a scalable way, as the technology became generally available. A non-limiting example of one such scalable, automated SIEM platform is disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is herein incorporated by reference in its entirety.

Although SIEM platforms can analyze multiple data sources, perform sophisticated correlation to identify threats, and intelligently rank identified events in order of criticality, Security Orchestration, Automation, and Response (“SOAR”) platforms can be implemented to automate investigation path workflows based on SIEM-generated alerts to significantly cut down on the amount of time required to manage and mitigate security threats. SOAR platforms boost MSSP productivity via a collection of security software solutions and tools for browsing and collecting diverse data from a variety of sources to be analyzed, in order to comprehend and prioritize security incident response actions. Essentially, SOAR platforms are implemented as an integrated development environment built on top of a collection of application program interfaces (“API”) bridges that allow modules of code, described herein as “playbooks,” to automatically collect data and communicate commands, or orchestrated responses, back to the underlying systems. In other words, SOAR platforms not only allow companies to collect threat-related data from a range of sources, but can identify and respond to identified threats based on the analysis. Once a threat is identified, the typical SOAR platform can secure the network by implementing an incident response that mitigates the identified threat.

Traditionally, SOAR platforms have been designed to automate an incident response lifecycle by increasing a cyber defense team's ability to detect, investigate, and respond to security alerts in a given environment, either manually or via the use of automation. However, in order to realize their full potential, SOAR platforms require a high degree of integration into an environment to realize their full potential, as well as customized playbooks and response activity. Accordingly, conventional SOAR platforms are generally managed by an implementing organization directly, because the organization is better positioned to integrate the platform into its network and is able to myopically manage its own, single network. In order for a SOAR platform to be managed by a service provider, manual integration would be required to achieve the proper degree of integration to fully protect the client organization's network. In other words, a lot of manual labor and though is required to establish sufficient connections to the variety of SOAR platforms and API's implemented by each client organization.

This can result in a high cost for both the MSSP—who must hire more expensive specialists—and for the client organization, who often bears at least a portion of the increasing expenses. However, there is often an overlap between some of the deployment needs of varying client organizations. For example, many organizations utilize similar SOAR platforms and may require similar monitoring and management solutions. In such instances, asset reuse, re-deployment, and updates may lead to major cost reduction, and a simplicity of operation. Unfortunately, known SIEM tools are technologically incapable of taking advantage of such synergies. Thus, from the initial provisioning, and throughout the automation of incident responses, MSSPs are left with limited re-use opportunities to capture efficiencies across multiple clients. Not only can a lack of reusable deployments be extremely expensive, but it can also be inherently unscalable, as each client organization's network is different, has different capabilities of detection, and has different levels of risk tolerance. Many client organizations may be skeptical and hesitant to proceed with an automated SOAR platform that, at a minimum, may mitigate the expense driven by manual implementation, although automation alone won't enhance the scalability of conventional SOAR platforms.

Furthermore, the need for scalable SIEM/SOAR services is accompanied by an emerging need to quickly provision, or configure, an SIEM/SOAR platform, such that the MSSP can immediately begin monitoring the security of new clients. Once configured, the SIEM must also be updated on a recurring (e.g., daily, weekly, monthly, etc.) and/or ad hoc basis. Since information technology requirements and security threats are continually evolving, such SIEM/SOAR updates should be able to address new client needs (e.g., new log sources) and should include new security content (e.g., alerts, playbooks, etc.).

Conventional SOAR technologies, moreover, have a critical shortcoming. Specifically, conventional SOAR platforms are technologically devoid of the robust data storage required to facilitate the amount of data necessary to scale and enrich MSSP services for multiple tenants. Effectively scaling an MSSP's services would implicate a massive number of data sources and potential response destinations that conventional SOAR platforms are not technologically configured to interface with and/or manage. In other words, the amount of data would be too large and conventional SOAR platform is not configured to ingest the volume of data from so many tenants, process it, and disposition it to take the proper security action. Accordingly, conventional SOAR platforms are technologically incapable of continuously monitoring networks for multiple tenants simultaneously—let alone implement playbooks to secure those networks. Accordingly, there is a need for improved devices, systems, and methods for improved devices, systems, and methods for ingesting, enriching, and transforming security information to autonomously secure a plurality of tenant networks.

The present disclosure contemplates such devices, systems, and methods, all of which provide many technological benefits over conventional MSSP and SIEM platforms. For example, conventional MSSP devices, systems, and methods lack the automation, artifacts, and interfaces required to seamlessly scale an MSSP platform such that SIEM services can be provided to hundreds, if not thousands, of tenant networks. Rather, conventional MSSP devices, systems, and methods require manual integration and management, meaning they are less efficient and more expensive. Moreover, conventional MSSP devices, systems, and methods require each tenant network to share the manual resources employed by the MSSP, rendering each tenant network less secure. In contrast, the devices, systems, and methods disclosed herein are highly automated and thus, configured to enable an MSSP to continuously monitor a tenant's network and clients in real-time. Not only are conventional MSSP devices, systems, and methods technologically incapable of such automation, but it would be highly impractical—if not impossible—for an MSSP to manually continuously monitor hundreds, if not thousands, of tenant networks in real-time. The devices, systems, and methods disclosed herein are also technologically configured to be adaptable. In conjunction with being highly scalable, this adaptability enables and MSSP to track changes across a high volume of tenant deployments, monitor responses to those changes, and autonomously implement them for any applicable tenant deployment that could similarly benefit from them. In other words, conventional MSSP devices, systems, and methods are inherently more prone security events and thus, technologically less secure than the devices, systems, and methods disclosed herein.

For example, the devices, systems, and methods disclosed herein can provide: (1) a means of dynamically plugging-in a JavaScript Object Notation (“JSON”) based solution bundle descriptions of various Sentinel artifacts (e.g., resource groups, log analytics workspaces, data connectors, alert rules, playbooks, workbooks, etc.), which shall be referred to as a “sentinel-in-a-Box,” herein; (2) a visual interface for an authorized user to select a desired sentinel-in-a-box bundle; (3) an action button to “deploy” the selected bundle to a user's desired SIEM subscription, essentially creating all the necessary artifacts (e.g., resource group, log analytics workspace, etc.), configuring appropriate data connectors (specific to the chosen bundle), and creating the analytics/alert rules needed for the solution, as well as any playbook, workbooks, queries, as needed by the particular bundled configuration; (4) Configures the back end service operating center (SOC) to onboard a new client, with well defined automation rules in response to the events triggered by the alerts/detections configured for the particular bundle; and (5) an MSSP/CSP model: a service provider who has access to their clients Azure environment (e.g., via Azure Lighthouse, etc.) can deploy bundles, on behalf of their clients, into each client workspace. Accordingly, the bundle provider only manages the relationship with the MSSP/CSP, with enough filtering by client workspace in responding to specific alerts/incidents. This could be important for the efficiency of billing, support, and avoiding unnecessary client interactions.

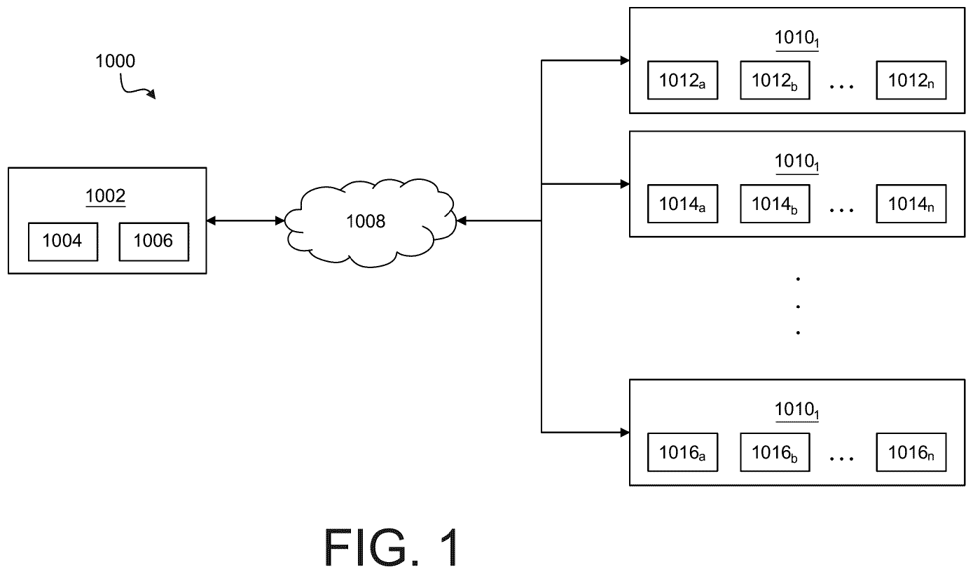

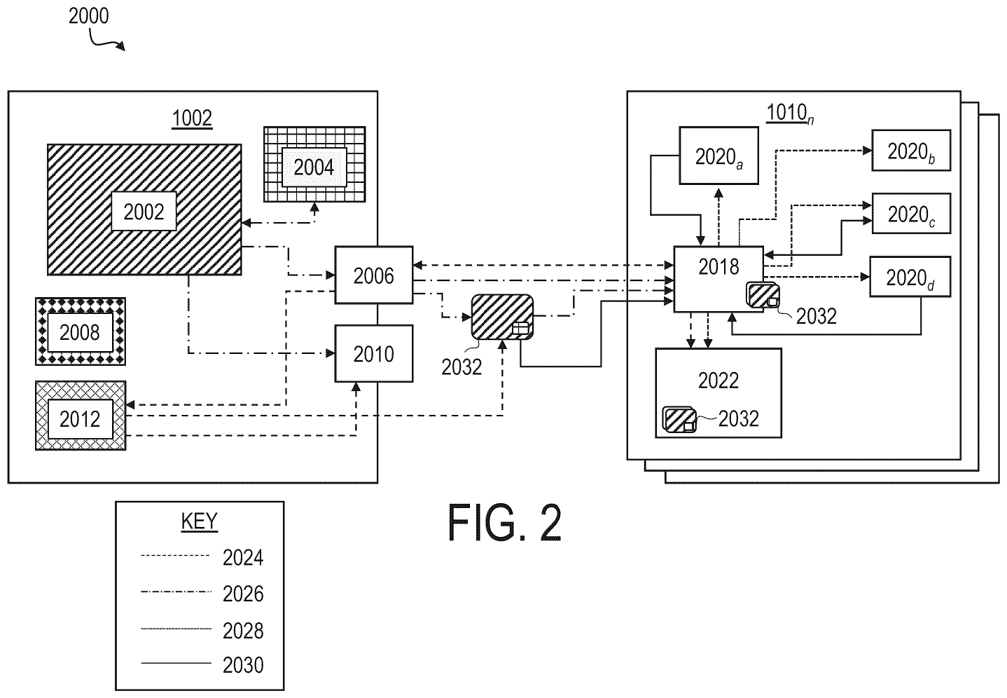

Referring now to FIG. 1, a block diagram of a system 1000 configured to remotely manage another organization's Security Orchestration, Automation, and Response (“SOAR”) is depicted in accordance with at least one non-limiting aspect of the present disclosure. According to the non-limiting aspect of FIG. 1, the system 1000 can include a MSSP provider server 1002 comprising a memory 1006 configured to store a SOAR application (see FIG. 2), and a processor 1004 configured to execute a stored SOAR application (see FIG. 2), as will be discussed in further reference to FIG. 2. For example, the MSSP provider server 1002 can be a computational resource either owned or leased by the managed security service provider (“MSSP”). The MSSP provider server 1002 can be communicably coupled, via network 1008, to a plurality of tenants 1010₁, 1010₂ . . . 1010n. Each tenant 1010₁, 1010₂ . . . 1010ₙ of the plurality can represent a customer (e.g., organization) contracting with the MSSP. According to the non-limiting aspect of FIG. 1, the network 1008 can include any variety of wired, long-range wireless, and/or short-range wireless networks. For example, the network 1008 can include an internal network, a Local Area Networks (LAN), WiFi®, cellular networks, near-field communication (hereinafter “NFC”), amongst others. The MSSP provider server 1002 can be configured to perform SIEM services and, more specifically, SOAR management services on behalf of a plurality of tenants 1010₁, 1010₂ . . . 1010ₙ.

In further reference to FIG. 1, each tenant 1010₁, 1010₂ . . . 1010ₙ of the plurality can host one or more instances of one or more clients 1012, 1014, 1016. For example, a first tenant 1010₁ can include one or more machines implementing one or more client applications 1012₁, 1012₂ . . . 1012ₙ, a second tenant 1010₂ can include one or more machines implementing one or more client applications 1014₁, 1014₂ . . . 1014ₙ, and/or a third tenant 1010ₙ can include one or more machines implementing one or more client applications 1016₁, 1016₂ . . . 1016ₙ. Each tenant 1010₁, 1010₂, and 1010ₙ can include an intranet by which each machine implementing the client applications. For example, each tenant 1010₁, 1010₂, and 1010ₙ can each represent a customer, such as an organization, contracting with the MSSP for security services.

Accordingly, the MSSP provider server 1002 can be configured to have oversight of each tenant 1010₁, 1010₂, and 1010ₙ of the plurality, and thus, is responsible for monitoring, and managing each client application 1012, 1014, 1016 for threats. As previously discussed, the differences, and complexity in tenant 1010₁, 1010₂, and 1010ₙ architecture can complicate this, and render it inefficient for the MSSP. Thus, known SOAR tools can leave the tenants 1010₁, 1010₂, and 1010ₙ technologically exposed, and thus, vulnerable to attacks. According to non-limiting aspects of the present disclosure, the MSSP provider server 1002 can implement a SOAR management application (see FIG. 2) that technologically, and practically addresses these deficiencies by enhancing the ability of the MSSP provider server 1002 to manage, and transmit alerts, and client application updates for multiple tenants based on correlated, and synergistic development needs. Moreover, the architecture 2000 of FIG. 2 further illustrates different means of communication between the various modules and

Referring now to FIG. 2, a block diagram of a functional architecture 2000 of the system 1000 of FIG. 1 is depicted in accordance with at least one non-limiting aspect of the present disclosure. According to the non-limiting aspect of FIG. 2, the architecture 2000 can include a content library 2002, a variable store 2004, an automation schema 2008, and a service operation engine 2012 collectively provided via an application stored in the memory 1006 (FIG. 1) of the MSSP provider server 1002. According to some non-limiting aspects, the MSSP provider server 1002 can be remotely located relative the MSSP and/or tenenat 1010ₙ. For example, the MSSP provider server 1002 may be cloud-based. When executed by the processor 1004 (FIG. 1), the application's content library 2002, variable store 2004, automation schema 2008, and service operation engine 2012 can collectively facilitate the simultaneous configuration, management, and/or control of multiple SOAR platforms 2018 for multiple tenants 1010ₙ, or client organizations, at scale. Moreover, when executed by the processor 1004 (FIG. 1), the application can support a client organization's SOAR platform 2018 in either an abstract or a dynamic way, as will be described in further detail herein.

According to some non-limiting aspects, the application deployed by the MSSP provider server 1002 can be configured as an Azure Sentinel Automation Portal (ASAP), as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. For example, according to one non-limiting aspect, an ASAP portal runtime software code can include server middleware that is responsible for processing the content from the content library 2002, the connections to the SOAR platform 2018, and/or other services, and services requests for the MSSP provider server 1002 to deploy, update, and/or read. In other words, the application deployed by the MSSP provider server 1002, including the content library 2002, the variable store 2004, and the automation schema 2008, can provide a unified, simplified view of all tenant 1010₁₋ₙ (FIG. 1) deployments, in conjunction with an ability to work with one or multiple tenants 1010₁₋ₙ at the same time.

The content library 2002 can be configured to store various artifacts (e.g., detections, automations, workbooks, alert rules, playbooks, etc.) by which the MSSP provider server 1002 can configure and manage a SOAR platform for one or more tenants 1010ₙ. According to some non-limiting aspects, the content library 2002 of FIG. 2 can be stored locally relative to the application, meaning it is provided via the memory 1006 (FIG. 1) of the MSSP provider server 1002. However, according to other non-limiting aspects, the content library 2002 can be stored on a remote server communicably coupled to the MSSP provider server 1002. In still other non-limiting aspects, the content library 2002 can be provided by a third-party provider (e.g., GitHub, GitLab, etc.). In summary, the content library 2002—and more specifically, artifacts stored within the content library 2002—controls rules by which the MSSP provider server 1002 can remotely interface with and/or manage a SOAR platform 2018 for the tenant 1010ₙ, or client organization. For example, the content library 2002 can store one or more rules and/or a template configured to automate the deactivation of a user account if the MSSP provider server 1002 and/or SOAR platform 2018 determines that, based on detected variables throughout the tenant architecture 1010ₙ, a determined risk score exceeds a predetermined threshold.

According to the non-limiting aspect of FIG. 2, tenant 1010ₙ requirements, such as variability points, that are specific to a particular client organization and/or tenant 1010ₙ architecture can be provided to artifacts stored in the content library 2002. The content library 2002 can achieve this in accordance with a deployable artifact template, as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. For example, the content library 2002 can contain “json” files for defining alert rules, workbooks, playbooks, etc. As new content is added to the content library 2002 or existing content is updated, the changes can be automatically pushed via the MSSP provider server 1002 to the SOAR platform 2018 of the tenant 1010ₙ. In other words, the MSSP provider server 1002, when deployed, can be configured configured for each tenant's 1010₁₋ₙ (FIG. 1) specific SOAR needs, which will vary based on each tenant's architecture.

The variable store 2004 can be configured to further customize the interface between the MSSP provider server 1002 and the tenant 1010ₙ, or client organization's, architecture. For example, the variable store 2004 can enable a user of the MSSP provider server 1002, such as an MSSP, to define and/or link variables associated with the tenant 1010ₙ architecture, as detected by the MSSP provider server 1002, to various artifacts stored in the content library 2002, which enhances the ability of the MSSP provider server 1002 to automate a client-specific implementation. According to some non-limiting aspects, the MSSP provider server 1002 can automatically configure the tenant 1010ₙ dependent on variables defined by the user.

The automation schema 2008 can be configured to recognize commonalities between various tenant 1010₁₋ₙ (FIG. 1) architectures and standardize the implementation of the MSSP provider server 1002. This represents a significant technological improvement beyond a conventional SOAR management platform, which is configured to either be implemented for a single client organization or would require a significant amount of manual labor to implement across multiple tenants 1010₁₋ₙ, or client organizations. For example, conventional SOAR platforms require the assessment of client-specific environments and needs, which requires the design and implementation of a custom solution. The automation schema 2008 of FIG. 2, in conjunction with the content library 2002 and the variable store 2004, enable the MSSP provider server 1002 of FIGS. 1 and 2 to automatically generate customized SOAR solutions and scale such solutions across an unprecedented number of tenants 1010₁₋ₙ, or client organizations, simultaneously.

The application launched by the MSSP provider server 1002 can further include an API broker 2006 and a graphical user interface 2010 configured to visually present information and receive user inputs via a display and/or a peripheral device (e.g., keyboard, mouse, touchscreen, etc.) communicably coupled to the MSSP provider server 1002. For example, the graphical user interface 2010 can be configured to run a wizard through which a user may control the setup and/or automation of the SOAR platform for one or more tenants 1010ₙ, or client organizations.

In further reference to FIG. 2, an example of one such tenant 1010ₙ architecture is depicted in accordance with at least one non-limiting aspect of the present disclosure. The MSSP provider server 1002 can be configured to detect variables associated with the tenant 1010ₙ architecture, as well as design and deploy a tenant 1010ₙ specific configuration including one or more of the modules illustrated in FIG. 2. For example, according to the non-limiting aspect of FIG. 2, the tenant 1010ₙ architecture can include a remote SOAR platform 2018, a dashboard/reporting module 2022, and one or more security tool application program interfaces (“API's”) 2020_{a-d}. Each security tool API 2020_{a-d} can be configured to prevent malicious attacks on, or misuse of, a client's API's deployed on the tenant 1010ₙ. Because APIs have become key to programming web-based interactions, they have become a target for hackers. Thus, the security tool API's 2020_{a-d} can monitor the client's API's and transmit an alert 2030 back to the SOAR platform 2018 if a suspicious event is detected.

According to some non-limiting aspects, the dashboard/reporting module 2022 can include a customizable, visual representation of the tenent's 1010ₙ cyber security. For example, dashboard/reporting module 2022 can enable the MSSP and/or employees of the client organization to see what is happening across the tenant 1010ₙ network and take remedial actions to secure the network in response to identified threats. This can help the MSSP and/or client organization identify, prevent, mitigate, and/or predict cybersecurity incidents in a significantly more efficient way. Of course, the specific tenant 1010ₙ architecture of FIG. 2 is merely presented for illustrative purposes. According to other non-limiting aspects, the tenant 1010ₙ architecture designed and deployed by the MSSP provider server 1002 can be alternately configured to include alternate types and/or quantities of modules. The ability of the MSSP provider server 1002—and more specifically, the content library 2002, the variable store 2004, and the automation schema 2008—enables customized SOAR-based solutions that can be remotely managed on behalf of the tenant 1010ₙ. Each solution is different, depending on the variables detected by the variable store 2004 and artifacts selected from the content library 2002 based on the detected variables, as deployed by the MSSP provider server 1002.

Moreover, the architecture 2000 of FIG. 2 further illustrates different means of communication between the various modules of the MSSP provider server 1002 and the one or more tenants 1010ₙ. According to some non-limiting aspects, a TCP/HTTP protocol can be used for communication between the layers. According to other non-limiting aspects an RPC and/or MQ protocol can be used. Different layers can be used to provide separation between different modules and each module can have one or many different access points for each layer. For example, HTTP endpoints can be used for service calls, file upload methods can be used for content, and/or database access protocols/standards can be used for management.

According to other non-limiting aspects, certain modules, such as the API broker 2006 may communicate with other modules, such as the service operation engine 2012, the graphical user interface 2010, the remote SOAR platform 2018, and the dashboard/reporting module 2022 via a service layer 2024. Other modules, such as the content library 2002, the variable store 2004, and the API broker 2006, may communicate with the remote SOAR platform 2018 of the tenant 1010ₙ via a management and content delivery layer 2026. The remote SOAR platform 2018 may communicate with the one or more security tool API's 2020_{a-c} of the tenant 1010ₙ via a SOAR communication protocol 2028. The one or more security tool APIs may communicate alerts back to the remote SOAR platform 2018 in accordance with rules defined by the applied artifacts 2032 from the content library 2002, as defined by variables from the variable store 2004, via an alert protocol 2030. In other words, the MSSP provider server 1002 can provide various visual indicia (e.g., shapes, colors, icons, etc.) that correlate to each of the various automations available to a user and/or tenant 1010ₙ. Non-limiting examples of such visual indicia are provided in U.S. Provisional Patent Application No. 63/302,828, titled DEVICES, SYSTEMS, AND METHODS FOR REMOTELY MANAGING ANOTHER ORGANIZATIONS SECURITY ORCHESTRATION, AUTOMATION, AND RESPONSE, and filed Jan. 25, 2022, the disclosure of which is hereby incorporated by reference in its entirety. Regardless, the influence that the selected artifacts from the content library 2002 and the detected variables from the variable store 2004 have on the artifacts 2032 are illustrated in FIG. 2 via corresponding cross-hatching.

As is illustrated in the non-limiting aspect of FIG. 2, the various modules of the architecture of the MSSP provider server 1002 may be configured to communicate with, manage, and control the remote SOAR platform 2018 of the tenant 1010ₙ in accordance with specific artifacts 2032 from the content library 2002, which are autonomously selected variables associated with the tenant 1010ₙ, as determined by and/or previously stored in the variable store 2004. Accordingly, the content library 2002 and variable store 2004, in conjunction with the automation schema 2008, can enable the MSSP provider server 1002 to autonomously generate a custom configuration to integrate with and remotely manage each tenant's 1010ₙ SOAR platform 2018. For example, an artifact 2032 can define the means by which the API broker 2006 and service operation engine 2012 of the MSSP provider server 1002 interface with the remote SOAR platform 2018 of the tenant 1010ₙ. Additionally, artifacts 2032 can further define the content alerts 2030 and the conditions under which they are sent from the one or more security tool API's 2020_{a-d} to the remote SOAR platform 2018.

The MSSP provider server 1002, including the content library 2002, variable store 2004, and automation schema 2008, can provide a powerful cloud-based tool by which MSSP's can remotely manage a client organizations SOAR platform 2018. Although the primary interface is the graphical user interface 2010, the API interface 2006 can further allow programmatic control of SOAR platform 2018 management capabilities, which enables a user to deploy content in the form of playbooks, automations, integrations, dashboards, and other SOAR controlling code-based content to remote environments, such as the tenant 1010ₙ, through a central interface. Additionally, the content library 2002, variable store 2004, and automation schema 2008 of the MSSP provider server 1002 provide features that allow the customization of that content and allow for bespoke deployments based on tenant 1010ₙ specific needs. In other words, the MSSP provider server 1002 can provide a modular and extensible way of referencing a stored library of code and content (e.g., the content library 2002) such that options may be autonomously decided at the time of deployment.

For example a user could deploy a series of artifacts stored in the content library 2002, such as playbooks, code, integrations, and/or dashboards, that can enable the integration of a next-generation antivirus (“NGAV”) product, an email security product, and/or an identity protection product and subsequently automate the stages of detection, investigation, and response based on controls they received from the user via the graphical user interface 2010. Additionally and/or alternatively, the MSSP provider server 1002 can enable a user to automate a portion of the tenant's 1010ₙ architecture or environment. Moreover, the graphical user interface 2010 can enable a user to “opt in” and/or “opt out” of automated features, as presented by the automation schema 2008, via an easy to follow wizard-like, walk through, application. The user can further customize reporting and/or dashboarding features and preferences to be applied via the dashboard/reporting module 2022, which can be packaged for deployment alongside the automated content.

According to some non-limiting aspects, the application launched by the MSSP provider server 1002 can be extensible, meaning it can be configured with the ability to extend or stretch in terms of the number of tenants 1010ₙ whose SOAR platforms 2018 it can remotely manage (e.g., scalability) and/or the number of SOAR management capabilities it provides. In other words, the application, including the content library 2002, the variable store 2004 and the automation schema 2008, can be designed to minimize the level of effort required to enable the MSSP provider server 1002 to be extended for future use. For example, through an extensibility mechanism provided by the application launched by the MSSP provider server 1002, pluggable add-ons configured to enable additional service components and features of the MSSP provider server 1002 can be deployed in the future. For example, according to some non-limiting aspects, the extensibility mechanism can be provided via a GUI, API, and/or code library that will enable a user to extend the functionality at pre-determined locations in the lifecycle. As long as the user follows the provided interface/abstraction, the MSSP provider server 1002 can transparently call a custom extension and/or enable an extension specific to the user and/or tenant 1010ₙ. When the user deploys these add-ons via automation, it can trigger the application launched by the MSSP provider server 1002 to enable additional subscription-based services on behalf of the MSSP, which can enhance the tenant's 1010ₙ security and health monitoring. Additionally and/or alternatively, the application deployed by the MSSP provider server 1002 can be configured to work with existing “unmanaged” content, which may enable at least some discovery and light management of the previous SOAR assets that are already deployed by the tenant 1010ₙ, in lieu of generating a completely new and customized tenant 1010ₙ architecture, as is depicted in FIG. 2.

As previously discussed, when executed by the processor 1004 (FIG. 1), the application can be configured to abstractly and/or dynamically manage a client organization's SOAR platform 2018. For example, in an abstract implementation, the MSSP provider server 1002 can employ generically-defined artifacts (e.g., automations) that are stored in the content library 2002, as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. Generically-defined artifacts, for example, can include a block of executable code. However, platform-specific implementations can be subsequently provided (e.g., Azure Defender, Crowdstrike, etc.).

Alternately, in a dynamic implementation, the MSSP provider server 1002 can dynamically generate new automation types via the content library 2002, which can be automatically detected by, and displayed for selection via, the graphical user interface 2010 for subsequent deployment. Similarly, new automations, such as endpoint monitoring solutions (e.g., CarbonBlack, etc.), can be added to the content library 2002 for a given automation type, such as those that block the execution of harmful programs detected by the automations (e.g., block executable file automations, etc.). Similar to, and it becomes automatically available to the GUI, and can be deployed to the appropriate client SOARs (that use those security tools).

Upon deployment via the MSSP provider server 1002, tenant 1010ₙ, or client, specific variability points can be detected by the variable store 2004 and correlated to artifacts stored in the content library 2002. For example, a variable point can include a specific customer or tenant 1010ₙ configuration, such as a region the customer tenant 1010ₙ belongs in, a specific vendor, and/or an enabled extension. Thus, at deployment, the variability points can be configured for tenant 1010ₙ specific SOAR needs, based on the network architecture of the tenant 1010ₙ. According to one non-limiting aspect, the MSSP provider server 1002 may automate the SOAR platform 2018 to block a user account upon detection of a security event based on inputs received by the security tool API's 2020_{a-d}. For example, the automation may include a number of steps or conditions, such as approval from a tenant 1010ₙ administrative account. During the deployment—for example via a wizard presented via the graphical user interface 2010—the automation may request the user to provide information (e.g., a phone number, a short message service (“SMS”) address, an email address, etc.) associated with one or more administrative accounts for the tenant 1010ₙ. Thus, particular steps and/or conditions, such as contacting and/or prompting action from the administrative account, can be programmed into the automation via the graphical user interface 2010.

According to one non-limiting aspect, upon running the custom automation, the MSSP provider server 1002—and more specifically, the custom automation generated by the MSSP provider server 1002—can manage the SOAR platform 2018 to detect a security event based on inputs/alerts received from one or more security tool API's 2020_{a-d}, and determine that a user account should be blocked. The MSSP provider server 1002 can manage the SOAR platform 2018 to notify the administrative account and the automation will wait for approval, and, upon receiving the approval, can continue on to subsequent steps of the automation, ultimately resulting in the removal of the suspect account from the tenant 1010ₙ network. As described earlier, this can be abstracted into the automation type, with specific implementations for each security tool API 2020_{a-d} and/or notification method.

Once deployed by the MSSP provider server 1002, the artifacts 2032 (e.g., automations) can reside in the tenant's 1010ₙ architecture and, depending on the non-limiting aspect, the MSSP and/or the client can modify the deployed configuration. For example, according to some non-limiting aspects, the client may desire to control the deployed configuration across the tenant 1010ₙ network. However, according to other non-limiting aspects, the client may desire for the MSSP to have exclusive control of the configuration. Regardless, the application deployed by the MSSP provider server 1002 can be configured to automatically detect changes made by the MSSP and/or the client and use them for future deployments and/or the management of updates to the already deployed artifacts 2032. According to some non-limiting aspects, such changes can be utilized by an artificial intelligence stored on the memory 1006 (FIG. 1) of the MSSP provider server 1002 to adapt one or more artifacts 2032 (e.g., templates, workflows, etc.) in the content library 2002 for enhanced deployments for similar clients and/or architectures.

Accordingly, the content library 2020 can serve as a contribution mechanism that, when deployed by the application on the MSSP provider server 1002, along with the graphical user interface 2010 and API broker 2006, can abstractly and/or dynamically detect updates to both the content library 2002 and the client's SOAR platform 2018. These updates can be collectively managed through the MSSP provider server 1002, which serves as a central console for the system 1000 (FIG. 1), and can enable unprecedented scalability to manage a great number of clients. As such, the MSSP provider server 1002 can remotely manage another client's SOAR platform 2018 with reliability and consistency. Due to its modular design, it can also be “future proofed,” allowing users and third party applications to contribute new artifacts 2032 and/or update existing artifacts 2032 them, as third party vendor solutions evolve.

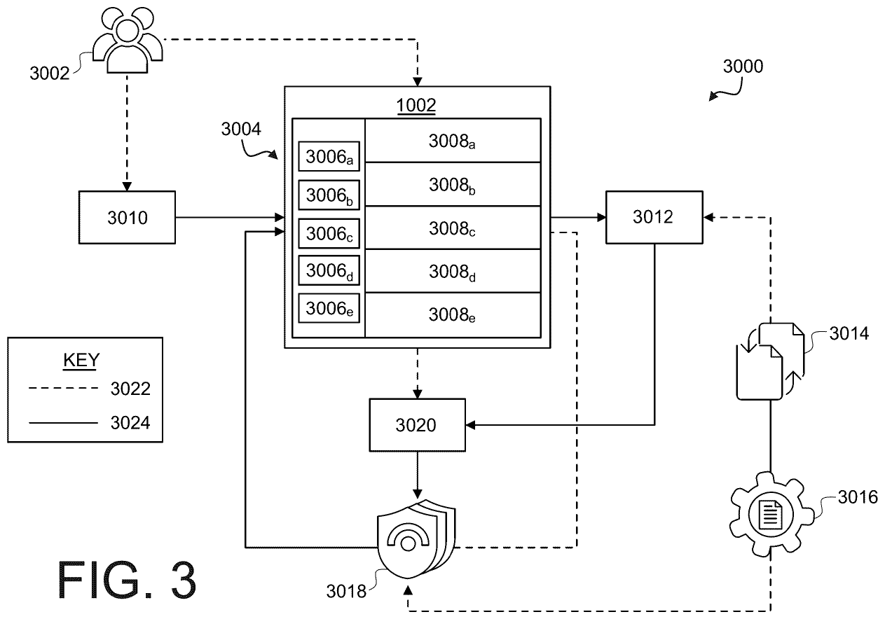

Referring now to FIG. 3, a block diagram of a deployment architecture 3000 employed by the system 1000 of FIG. 1 is depicted in accordance with at least one non-limiting aspect of the present disclosure. According to the non-limiting aspect of FIG. 3, a user 3002 (e.g., an MSSP) can access an MSSP system 3004 that includes a graphical user interface featuring a plurality of widgets 3006ₐ₋ₑ, 3008ₐ₋ₑ by which the user 3002 can initiate the provisioning and/or updating of an SIEM for a plurality of tenants 1010₁₋ₙ (FIG. 1). The MSSP system 3004 can be stored in the memory 1006 of the MSSP provider server 1002 (FIG. 1) and, when executed by the processor 1004 (FIG. 1) of the MSSP provider server 1002 (FIG. 1), the graphical user interface can be presented on a display communicably coupled to the MSSP provider server 1002 (FIG. 1). According to some non-limiting aspects, the MSSP system 3004 of FIG. 3 can be similar to those disclosed in U.S. Provisional Patent Application No. 63/196,458, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed Jun. 3, 2021. However, the MSSP system 3004 of FIG. 3 can include alternate mechanisms that facilitate enhanced SIEM provisioning, management, and updating, as will be described in further detail herein. In other words, the MSSP management system 3004 can include a visual representation, or “dashboard,” configured to display data, trends, and/or anomalies associated with security activities and events across the plurality of tenants 1010₁₋ₙ (FIG. 1). Different lines of communication 3022, 3024 between the system components of the architecture are further illustrated.

According to the non-limiting aspect of FIG. 3, the MSSP provider server 1002 (FIG. 1) can be communicably coupled to a content repository 3010, which can be accessed by the user 3002 via the MSSP system 3004. The content repository 3010, via the MSSP management system 3004, can enable a user 3002 to search and retrieve such content. Additionally, the content repository 3010 can be configured to actively interface with the MSSP management system 3004 such that the MSSP system 3004 can autonomously access, correlate, and implement content within the repository 3010 for a tenant-specific implementation. The MSSP system 3004, in conjunction with the content repository 3010, can visualize available artifacts for tenant 1010₁₋ₙ (FIG. 1) specific SIEM deployments, available changes for the SIEM deployments, and various other deployment tasks. According to some non-limiting aspects, the content repository 3010 can be client-specific. However, according to other non-limiting aspects, the content repository 3010 can be provided via a third-party (e.g., Splunk, Sentinel, GitHub, etc.). Regardless, the content repository 3010 can be a database configured to store digital content, such as artifacts and/or SIEM implementation and management solutions (e.g., resource groups, log analytics workspaces, data connectors, alert rules, playbooks, workbooks, etc.).

For example, the content repository 3010 can store a workbook, which can assist in visualizing data associated with each of the clients 1012ₐ₋ₙ, 1014ₐ₋ₙ, 1016ₐ₋ₙ of the plurality of tenants 1010₁₋ₙ (FIG. 1). Additionally and/or alternatively, the content repository 3010 can store a playbook, or protocols which can be run by the MSSP provider server 1002 and/or the tenant 1010₁₋ₙ (FIG. 1) in response to a security event and/or an alert, at the direction of the MSSP system 3004. Generally, the SIEM implementation 3018 can be configured to secure a network on behalf of each of the tenants 1010₁₋ₙ (FIG. 1). For example, the SIEM implementation 3018 can monitor the network for a security event, and take an action to secure the network. According to some non-limiting aspects, the action can include issuing an alert to an MSSP user 3002 and/or an administrative account for the tenant 1010₁₋ₙ (FIG. 1). However, according to some non-limiting aspects, the SIEM implementation 3018 can identify and remove a suspect account from the tenant 1010ₙ₋₁ network based on one or more artifacts.

As previously discussed, the MSSP management system 3004 can include a graphical user interface that includes a plurality of widgets 3006ₐ₋ₑ, 3008ₐ₋ₑ by which the user 3002 can initiate the provisioning and/or updating of an SIEM for a plurality of tenants 1010₁₋ₙ (FIG. 1). For example, according to some non-limiting aspects, the graphical user interface of the MSSP management system 3004 of FIG. 3 is similar to any of the graphical user interfaces disclosed in U.S. Provisional Patent Application No. 63/196,991, titled DEVICES, SYSTEMS, AND METHODS FOR STANDARDIZING AND STREAMLINING THE DEPLOYMENT OF SECURITY INFORMATION AND EVENT MANAGEMENT ARTIFACTS FOR MULTIPLE TENANTS, filed Jun. 4, 2021. According to the non-limiting aspect of FIG. 3, the graphical user interface can include a first plurality of widgets 3006ₐ₋ₑ, wherein each widget 3006ₐ₋ₑ of the first plurality of widgets 3006ₐ₋ₑ corresponds to a tenant 1010₁₋ₙ (FIG. 1) of the plurality of tenants 1010₁₋ₙ (FIG. 1). Additionally, the graphical user interface can include a second plurality of widgets 3008ₐ₋ₑ, wherein each widget 3008ₐ₋ₑ of the second plurality of widgets 3008ₐ₋ₑ corresponds to a SIEM implementation and/or SIEM status for each tenant 1010₁₋ₙ (FIG. 1) of the plurality of tenants 1010₁₋ₙ (FIG. 1).

In further reference to FIG. 3, the MSSP management system 3004 and the MSSP provider server 1002 can be configured for the provision of an SIEM implementation 3018 to a tenant network 3020 of one or more new tenants 1010₁₋ₙ (FIG. 1). For example, according to the non-limiting aspect of FIG. 3, the MSSP management system 3004 can prompt the user 3002 to select and/or create a desired tenant 1010₁₋ₙ (FIG. 1) profile, as well as a particular artifact (e.g., alerts rules, playbooks, workbooks, etc) to deploy from the content repository 3010 for implementation on the selected tenant 1010₁₋ₙ (FIG. 1). Upon receiving the inputs from the user 3002, the MSSP management system 3004 can autonomously generate and aggregate the required scripts, customized content, and any other artifacts necessary into a tenant-specific repository 3012. The use of a tenant-specific repository 3012 differentiates the MSSP provider server 1002 and the MSSP management system 3004 from conventional MMSP tools since, instead of actually deploying content from the repository 3010 directly to the tenant 1010₁₋ₙ (FIG. 1), the tenant 1010₁₋ₙ (FIG. 1) pulls the content, which has been intelligently and autonomously curated by the MSSP management system 3004 for the specific tenant 1010₁₋ₙ (FIG. 1), from the tenant-specific repository 3012. Alternately, the MSSP management system 3004 can include a scripting engine configured to push content from the tenant-specific repository 3012 to the tenant 10101-n (FIG. 1). In other words, the MSSP management system 3004 can be specifically configured to autonomously deploy initial SIEM implementations 3018 on behalf of a tenant 1010₁₋ₙ (FIG. 1) or provide the SIEM implementation 3018 to the tenant-specific repository 3012 for the tenant 1010₁₋ₙ (FIG. 1) to deploy on their own accord, depending on the preferences of the tenant 1010₁₋ₙ (FIG. 1). Regardless, the MSSP management system 3004 can generate a custom SIEM implementation 3018 for a specific tenant 1010₁₋ₙ (FIG. 1) to be provisioned the the tenant 1010₁₋ₙ (FIG. 1). Notably, the MSSP management system 3004 and the MSSP provider server 1002 of FIG. 3 can facilitate the provision of an SIEM implementation 3018 for a new tenant 1010₁₋ₙ (FIG. 1) without requiring the user 3002 to write new scripts or modify existing scripts to match tenant 1010₁₋ₙ (FIG. 1) specific environment and/or deployment needs.

Additionally, the architecture 3000 of FIG. 3 can further include an SIEM update engine 3014 the MSSP management system 3004 and the MSSP provider server 1002 of FIG. 3 can be configured to update artifacts stored in the tenant-specific repository 3012 and/or the content repository 3010. According to the non-limiting aspect of FIG. 3, the update engine 3014 can be configured to assess existing SIEM implementations 3018, compare one or more SIEM implementations 3018 deployed across one ore more tenants 1010₁₋ₙ (FIG. 1), notify the MSSP, and autonomously determine whether to keep or reject any proposed changes to an existing, tenant-specific SIEM implementation 3018. As content is updated, the changes are registered via the MSSP management system 3004 and displayed via the graphical user interface and/or by a job scheduling engine 3016, such as a cron command-line utility or equivalents. In some non-limiting aspects, the job scheduling engine 3016 may be provided by a third party. Accordingly, the MSSP management system 3004 and the MSSP provider server 1002 can autonomously ensure the tenant-specific repository 3012 has the most up-to-date SIEM implementation 3018 for the tenant's 1010₁₋ₙ (FIG. 1) specific environment and/or deployment needs, which renders tenant-specific repository 3012 prepared for the provision of future SIEM implementations 3018 and/or updates.

Still referring to FIG. 3, the MSSP provider server 1002 can be configured to monitor the tenant-specific repository 3012 and/or the content repository 3010 for content changes via custom callbacks. For example, according to some non-limiting aspects, the MSSP management server 1002 can utilize autonomously initiate periodic webhooks and/or queries for content changes in the tenant-specific repository 3012 and/or the content repository 3010 and correlate, assess any detected changes for applicability to each tenant-specific repository 3012 and, upon determining that a detected change is applicable to a tenant-specific repository 3012, programmatically push each change to the applicable tenant-specific repository 3012. Further distinguishing the MSSP management system 3004 and the MSSP provider server 1002 from conventional devices is the ability to update the tenant-specific repository 3012 without requiring custom code. Furthermore, the MSSP management system 3004 and the MSSP provider server 1002 provide a simultaneous “one-click” SIEM update process for large numbers of tenants 1010₁₋ₙ (FIG. 1), in spite of their specific environment and deployment needs, due to the scalability of the system 1000 (FIG. 1), as described further in U.S. Provisional Patent Application No. 63/196,458, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed Jun. 3, 2021, the disclosure of which is herein incorporated by reference in its entirety.

Similar to the initial provisioning of the SIEM implementation 3018 to the tenant 1010₁₋ₙ (FIG. 1), once the content and/or artifacts in the tenant-specific repository 3012 have been updated, the deployment of the system 1000 (FIG. 1) can be configured to update artifacts for any of the previously provisioned SIEM implementations 3018 for any tenant 1010₁₋ₙ of the plurality of tenants 1010₁₋ₙ. Specifically, the tenant 1010₁₋ₙ (FIG. 1) can pull the content, which has been intelligently and autonomously updated via the update engine 3014 for the specific tenant 1010₁₋ₙ (FIG. 1), from the tenant-specific repository 3012. Alternately, the MSSP management system 3004 can include a scripting engine configured to push the updated content from the tenant-specific repository 3012 to the tenant 10101-n (FIG. 1). In other words, the MSSP management system 3004 can be specifically configured to autonomously update SIEM on behalf of a tenant 1010₁₋ₙ (FIG. 1) or provide the SIEM implementation 3018 to the tenant-specific repository 3012 for the tenant 1010₁₋ₙ (FIG. 1) to deploy on their own accord, depending on the preferences of the tenant 1010₁₋ₙ (FIG. 1). According to some non-limiting aspects, updates to the SIEM implementation 3018 can be managed according a tenant's 1010₁₋ₙ (FIG. 1) lifecycle management, meaning the 1010₁₋ₙ (FIG. 1) may first approve the changes pushed to the tenant-specific repository 3012 before being deployed to the SIEM implementation 3018, itself. Regardless, the MSSP management system 3004 can customize and deploy an update for the SIEM implementation 3018 for a specific tenant 1010₁₋ₙ (FIG. 1).

For example, according to some non-limiting aspects, the MSSP management server 1002 can include a scripting engine configured to generate a script (e.g., repository command reference, a repository “commit” command, etc.) which autonomously initiates a periodic webhook and/or a query for content changes in the tenant-specific repository 3012 and/or the content repository 3010 and correlate, assess any detected changes for applicability to each tenant-specific repository 3012. Upon determining that a detected change is applicable to a tenant-specific repository 3012, the MSSP management server 1002 can programmatically push each change to the applicable tenant-specific repository 3012. This approach can further be enhanced to have the tenant-specific repository 3012 shared between groups of tenants 1010₁₋ₙ (FIG. 1) with similar environments and/or deployment needs.

According to some non-limiting aspects, a tenant 1010₁₋ₙ (FIG. 1) may want to make changes in their own environments. For example, a tenant 1010₁₋ₙ (FIG. 1) may choose to alter and/or eliminate a deployed alert rule, a workbook, etc. The job scheduling engine 3016, for example a regular cron job, can detect tenant 1010₁₋ₙ (FIG. 1) initiated profile changes and notify the MSSP via the MSSP management system 3004. The MSSP can then decide whether or not to keep the tenant 1010₁₋ₙ (FIG. 1) initiated changes by providing inputs via the graphical user interface. Additionally, the MSSP management system 3004 can enable the MSSP to lock the tenant 1010₁₋ₙ (FIG. 1) initiated changes from automatic updates, or can outright reject them such that future implemented updates to the SIEM implementation 3018 will override the tenant 1010₁₋ₙ (FIG. 1) initiated changes.

In further reference to FIG. 3, the architecture 3000 and the system 1000 (FIG. 1) on which it is implemented can allow a user 3002 to perform large scale deployments and updates of SIEM implementations 3018, monitoring changes to deployed SIEM implementations 3018 across a plurality of tenants 1010₁₋ₙ (FIG. 1) via tenant-specific repositories 3012. In conjunction with other SIEM portals, such as those disclosed in U.S. Provisional Patent Application No. 63/196,458, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed Jun. 3, 3021, the disclosure of which is hereby incorporated by reference in its entirety, can provide a user 3002 with a complete management of deployed SIEM implementations 3018. However, the architecture 3000 of FIG. 3 provides further enhancements, integrating the portal and user interface with a scripted approach that allows updates without user 3002 intervention. According to some non-limiting aspects, the approach can be audited by a tenant 1010₁₋ₙ (FIG. 1). As such, users 3002 can track changes from deployment to deployment and/or rollback previously deployed changes in a far more efficient and scalable way than conventional systems.

Additionally and/or alternatively, the architecture 3000 and the system 1000 (FIG. 1) on which it is implemented can allow a tenant 1010₁₋ₙ (FIG. 1) to control its own SIEM implementation 3018 and make changes to artifacts deployed by the MSSP management system 3004. However, the MSSP management system 3004 can detect tenant 1010₁₋ₙ (FIG. 1) initiated changes, captures them in the tenant-specific repository 3012, generate and maintain an update history for the SIEM implementation 3018, while enabling a user 3002 to easily review and lock the tenant 1010₁₋ₙ (FIG. 1) initiated changes.

Currently, virtually all deployments are done manually, or if done via code (e.g., scripts) the MSSP is required to update said code with client specific information. This renders conventional systems error prone and requires a high degree of skill and understanding of the content being updated. As previously discussed, the initial provisioning of an SIEM via a conventional SIEM platform requires an MSSP to manually enter client specific information, such as a deployment location, credentials, and deployment content (e.g., alert rules, etc). However, whereas conventional SIEM platforms offer clients a graphical user interface through which initial SIEM provisioning and configuration is performed, the MSSP system 3004 of FIG. 3 can autonomously generate a custom deployment script (e.g., via an ARM template, a terraform, a powershell, etc.) to perform the initial SIEM provision and configuration, programmatically.

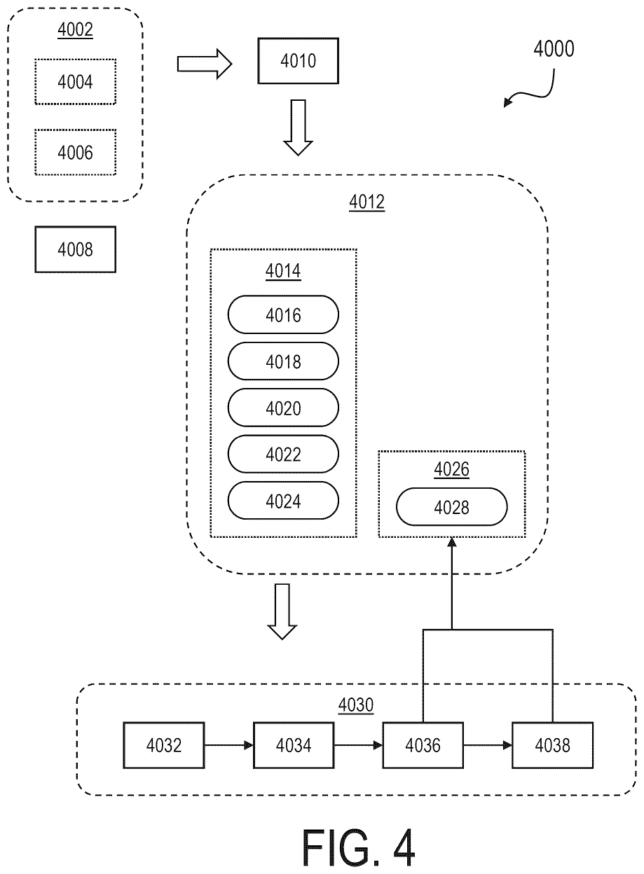

Since the quantity of tenants 1010₁₋ₙ (FIG. 1) monitored and managed by the system 100 of FIG. 1 via the architectures 2000, 3000 of FIGS. 2 and 3 is highly scalable, there is a need for devices, systems, and methods that will enable the MSSP server 1002 (FIG. 1) to ingest and enrich a large volume of security information from multiple sources, including various sources distributed across the plurality of tenants 1010₁₋ₙ (FIG. 1). Specifically, such devices, systems, and methods should interface with a wide variety of APIs and enrich those data sources via one or more automation processes. Referring now to FIG. 4, a platform 4000 configured to ingest and enrich a highly scalable quantity of security information via automation is depicted in accordance with at least one non-limiting aspect of the present disclosure. The platform 4000, according to some non-limiting aspects, can be cloud-based and configured to remotely ingest and enrich security information relative to the sources of said information, such as the MSSP server 1002 and/or the plurality of tenants 1010₁₋ₙ (FIG. 1). According to the non-limiting aspect of FIG. 4, the platform 4000 can include a job manager 4010 and a workflow engine 4012. Collectively, the job manager 4010 and the workflow engine 4012 can enable the platform 4000 to quickly ingest, enrich, and transform a large, scalable, quantity of security information, which qualifies it for improved case management and an extensive collection of analytical use cases that far exceed the technological capabilities of conventional platforms.

The job manager 4010 can be configured to effectively and autonomously scale the ingestion of new data sources, such as the data sources 4002, 4004, 4006, 4008 depicted in FIG. 4. For example, the job manager 4010 can be configured to interface with data sources such as a configuration database 4002 that houses one or more security tools, including endpoint detection and response (“EDR”) tools 4004 (e.g., Sentinel, Carbon Black, Singularity, Falcon, Defender, Trend Micro XDR, etc.), detection as a service (“DaaS”) tools 4006 (e.g., Splunk, Mixpanel, Sentry, etc.), and/or vendor management (“VMS”) tools 4008 (e.g., Tenable, TripWire, Alert Logic, etc.). According to some non-limiting aspects, VMS can be accomplished via a slightly different process, but apart of the system as a whole. Think of it as a side-process. The job manager 4010 can be configured to execute one or more “fetch jobs,” which retrieve security information, (e.g. a security alert, device information, vulnerability data, user information, various security metadata, vendor related metadata, etc.) from the various sources 4002, 4004, 4006, 4008. As used herein, a “job” can include a unit of work for the system to fetch data for a specific configuration in the job manager, and the manager can be responsible for submitting various jobs.

According to some non-limiting aspects, such sources 4002, 4004, 4006, 4008 can be hosted by third-partied and contracted via the MSSP. Thus, the job manager 4010 can simultaneously run “n” number of fetch jobs, each corresponding to an “n” number of data sources, to collect the security information required by an architecture MSSP (e.g., architectures 2000, 3000 of FIGS. 3 and 4) to continuously monitor and secure each tenant 1010₁₋ₙ (FIG. 1) of the plurality of tenants 1010₁₋ₙ (FIG. 1). The job manager 4010 can accomplish this by performing a comprehensive scan of a configuration database 4002 and/or various other data sources 4004, 4006, 4008, in accordance with the one or more fetch jobs. As will described in further detail herein, the platform 4000 can then normalize security information it receives from the data sources 4002, 4004, 4006, 4008 into a common, standard format for processing via the workflow engine 4012.

In further reference to FIG. 4, security information that is retrieved by the job manager 4010 from each source 4002, 4004, 4006, 4008 can be transmitted to the workflow engine 4012, which can include an alert enrichment tool 4014 and a response and sync back tool 4026. The alert enrichment tool 4014, for example, can include a plurality of modules 4016, 4018, 4020, 4022, 4024 which can be collectively configured to enrich the security information collected by the job manager 4010, in accordance with an automation playbook, depending on an identified type (e.g., a EDR security alert, a SIEM/DaaS Security Alert, IoC data, etc.) associated with each particular piece of security information collected by the job manager 4010. Each on of these “types” would have a specific playbook to parse and contextualize the data. In some cases a playbook automation can call another playbook as well.

For example, the workflow engine 4012 can include a security alert enrichment module 4016, an indicator of compromise (“IOC”) extraction module 4018, a data normalization module 4020, a security operations center (“SOC”) automation module 4022, and/or a post-enrichment automation module 4024. Once the workflow engine 4012 receives security information from the job manager 4010, the enrichment module 4016 can enrich information, such as security alerts, based on various processes (e.g., simple look-up, parsing, contextualization, etc.), as predefined by a particular automation playbook, as deemed applicable by the SOC automation module 4022. Depending on the data type, information can be contextualized via lookups in the appropriate source or correlated with existing data already present in the system. As used herein “parsing” can refer to the standardization of the data, for each data type it can originate from multiple sources so we consolidate that information into a “common schema.” In other words, the enrichment module 4016, IOC extraction module 4018, and data normalization module 4020 can categorize and/or contextualize collected security information, in some non-limiting aspects using additional data and/or metadata, for further analysis and/or investigation to be performed via the SOC automation module 4022 and post-enrichment automation module 4024.

Specifically, the SOC automation module 4022 of the workflow engine 4012 of FIG. 4 can be configured to implement automated playbooks configured to perform an array of automated analyses, additional enrichment, etc. depending on the identified type of security information that has been enriched. Thus, the SOC automation module 4022 enables the workflow engine 4012 to risks identified based on security information collected by the job manager 4012, and respond to those risk rapidly and autonomously via a plurality of ready-to-deploy use cases. The playbooks employed by the SOC automation module 4022 can be predefined templates, customized, and/or autonomously updated via machine learning and/or artificial intelligence algorithms employed by the workflow engine 4012. As such, the SOC automation module 4022 enables the workflow engine 4012 to respond to security alerts with unprecedented speed and precision. The post-enrichment automation module 4024 can perform automated actions associated with assets distributed across a tenant 1010₁₋ₙ (FIG. 1) network. According to some non-limiting aspects, the enrichment can be based on a correlation between new incoming data and existing data that was previously collected. For example, according to such aspects, an alert can be tied to a computer asset, and the MSSP provider server 1002 can enable an automated response including actions dependent on the tenant 1010ₙ, a specific asset location, and/or a specific vendor. One such action can include remotely quarantining a suspect asset from the clients network via an automated mechanism.

For example, the post-enrichment automation module 4024 can enable the workflow engine 4012 to perform asset discovery scans, asset linking, classification activities, target prioritization, making it possible for an MSSP to autonomously operationalize its monitoring and/or tenant 1010₁₋ₙ (FIG. 1) network penetration efforts. In other words, the workflow engine 4012—and specifically, the various modules 4016, 4018, 4020, 4022, 4024—can enhance the individual security of each of a relatively large number of tenants 1010₁₋ₙ, relative to conventional devices, systems, and methods.

Still referring to FIG. 4, the workflow engine 4012 can include a security tool automation module 4028 configured to generate a security output based on the security information collected by the job manager 4010 and processed by the modules 4016, 4018, 4020, 4022, 4024 of the alert enrichment tool 4014. For example, the output can include a ticket, that prompts action from the tenant 1010₁₋ₙ (FIG. 1), and/or any other means of dispositioning the processed security information via a tenant security management system 4030 communicably coupled to the workflow engine 4012. According to some non-limiting aspects, the tenant security management system 4030 can be a server internal to the tenant 1010₁₋ₙ (FIG. 1) or provided by a third party, information technology service management provider—and specifically, one configured to manage security-based workflows (e.g., ServiceNow, SysAid, etc.). Regardless, the tenant security management system 4030 can be configured to initiate a workflow based on the output received from the workflow engine 4012, wherein the workflow includes a plurality of steps to be executed by one or more modules 4032, 4034, 4036, 4038 of the tenant security management system 4030. For example, the tenant security management system 4030 can include its own SOC automation module 4032, a workflow and communication module 4034, an SOC action module 4036, and/or a post-processing automation module 4038. Specifically, the SOC action module 4036 and the post-processing automation module 4038 can be configured to interface and interact with the response and sync back tool 4026 of the workflow engine 4012, which can include a security tool automation module 4028. The security tool automation module 4028 can be configured to execute a series of security actions across the tenant 1010₁₋ₙ infrastructure and can alter those actions based on inputs received from the SOC action module 4036 and the post-processing automation module 4038. In other words, the workflow engine 4012 and the tenant security management system 4030 can be configured to interact with one another, such that the workflow engine 4012 can autonomously generate and implement security actions that can be altered in real-time, in response to feedback provided by the tenant security management system 4030.

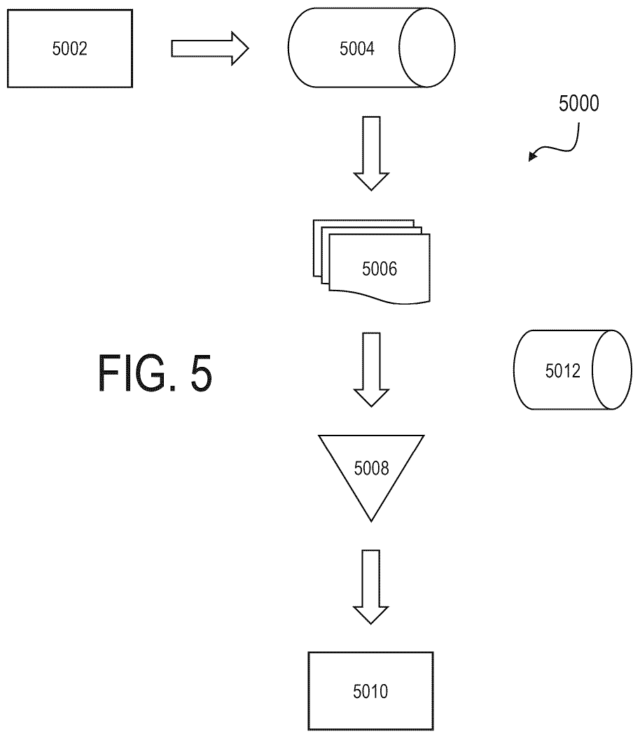

Referring now to FIG. 5, a logic flow diagram of a method 5000 of ingesting and enriching security information to autonomously secure a plurality of tenant networks using the platform 4000 of FIG. 4 is depicted in accordance with at least one non-limiting aspect of the present disclosure. According to the non-limiting aspect of FIG. 5, the method 5000 can include periodically running 5002, via the job manager 4010 (FIG. 4), a plurality of fetch jobs, wherein each job monitors a corresponding tenant 1010₁₋ₙ (FIG. 1) configuration, or integration, of a plurality of tenants 1010₁₋ₙ (FIG. 1). For example, the job manager 4010 (FIG. 4) may periodically run each fetch job once ever predetermined period of time, wherein the predetermined period of time can include a desired amount of seconds, minutes, or hours. According to some non-limiting aspects, each tenant 1010₁₋ₙ (FIG. 1) of the plurality can have its own, tenant-specified period of time during which the job manager 4010 (FIG. 4) runs a fetch job. According to some non-limiting aspects, the configuration may require tenant-specific credentials for the respective configuration environment. As previously discussed, each fetch job can contextualize monitored security information relative to information provided by sources 4002, 4004, 4006, 4008 wherein the security information is associated with each tenant 1010₁₋ₙ (FIG. 1) of the plurality of tenants 1010₁₋ₙ (FIG. 1). In other words, information collected via the fetching process may trigger a particular alert, which generates a job for the workflow manager 4012 (FIG. 4) associated with the alert.

In further reference to FIG. 5, the job manager 4010 (FIG. 4) can provide 1-n fetch instructions (or jobs associated with the gathered security information and/or alerts) to the workflow engine 4012 (FIG. 4). The method 5000 further includes queuing 5004, via the workflow engine 4012 (FIG. 4), the instructions, resulting in a queue 5006 of fetched instructions that need to be processed via the workflow engine 4012 (FIG. 4). According to some non-limiting aspects, the queuing 5004 can be performed based on a first-come, first-served basis. According to other non-limiting aspects, the queuing 5004 can be performed based on a priority basis. In still other non-limiting aspects, and optional queue 5012 can be generated for jobs of a similar priority and/or type. Regardless, the fetching 5002 and queuing 5004, and the resulting queue 5006 enables the MSSP to easily scale the security information ingestion, based on the queue 5006 size, ensuring that each tenant 1010₁₋ₙ receives the attention it needs from the workflow engine 4012 (FIG. 4) to enhance its network security. The workflow engine 4012 (FIG. 4) can then process 5008 the security information in the queue 5006 and generates 5010 an output, such as a ticket, as previously described. Specifically, the workflow engine 4012 (FIG. 4) can receive tenant-specific alerts from the sources 4002, 4004, 4006, 4008, perform enrichments, look ups, and parsing using a canonical model, or common information model (CIM), via the modules 4016, 4018, 4020, 4022, 4024 (FIG. 4), as previously described. The output can involve a main handler and/or a vendor handler, whom can disposition the output. The handler can disposition each tenant-specific output individually, or can disposition multiple outputs based on common tasks. For example, the handler can interact with the ticketing platform and data sources to sync data across the two. According to some non-limiting aspects, an alert can be outputted to a queue (e.g., ServiceNow) of the platform, where the handler can address the alert (e.g., close the alert as “Confirmed Bad”). The closure of the alert can be synced back to the source of the alert (e.g., Crowdstrike, Splunk, etc) and used for more efficient resolution of future generated alerts.

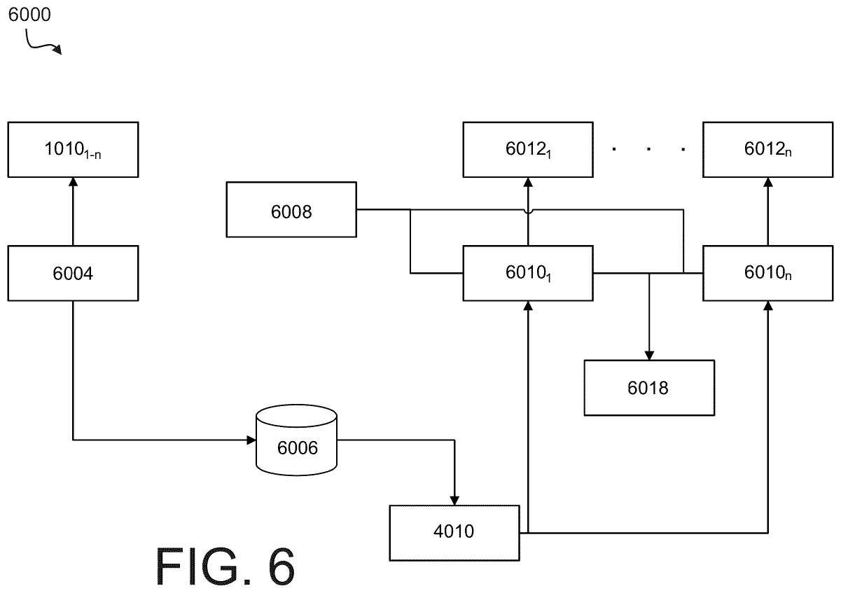

Referring now to FIG. 6, a framework 6000 for the job manager 4010 of the platform 4000 of FIG. 4 is depicted in accordance with at least one non-limiting aspect of the present disclosure. According to the non-limiting aspect of FIG. 6, the framework 6000 can include the job manager 4010, itself, which can be configured to interface and interact with a vault 6018, a fetch job database 6006, a configuration manager 6004, and a queue 6008 for a workflow engine 4012 (FIG. 4) for orchestrating parallel jobs fetched by the job manager 4010. The configuration manager 6004 can be configured to poll for changes in each tenant 1010₁₋ₙ (FIG. 1) network to be monitored by the job manager 4010, and add a row for every tenant 1010₁₋ₙ (FIG. 1) network and/or tenant-specific data source being monitored. Accordingly, the configuration manager 6004 can update existing data with a new polling interval and/or connection information and thus, update fetch job data that it collects and aggregates in the fetch job database 6006, which can be configured to store and maintain all appropriate parameters and configurations for each job type (e.g., for each data source 6012₁₋ₙ from which data is to be fetched). The fetch job database 6006 can further store and maintain status logs written by the job manager 4010, which can be consumed by a troubleshooting interface. The configuration manager can be configured to maintain the accuracy of the fetch job database 6006 and can ensure that each tenant 1010₁₋ₙ (FIG. 1) specific configuration is maintained relative to a corresponding database of each tenant's 1010₁₋ₙ data source 6012₁₋ₙ.

According to the non-limiting aspect of FIG. 6, the job manager 4010 can be further configured create fetch jobs for each tenant 1010₁₋ₙ (FIG. 1) of the plurality, invoke job parameters that determine how the job manager 4010 will operate. Additionally, the job manager 4010 can provide a status API configured to return a java script object notation (“JSON”) snapshot of the jobs table for troubleshooting the user interface. In other words, the job manager 4010 can generate fetch requests, or jobs, at appropriate intervals defined by each data source 6012₁₋ₙ and is responsible for invoking a job based on the parameters specified in the fetch job database 6006. For example, according to one non-limiting aspect, the parameters could require the job manager 1010 to fetch security information from a CarbonBlack cloud-based API every five minutes.

The job manager 4010 can furthermore invoke the fetch process by running one or more fetch jobs 6010₁₋ₙ configured to access one or more data sources 6012₁₋ₙ corresponding to each tenant 1010₁₋ₙ of the plurality of tenants 1010₁₋ₙ. For example, each fetch job 6010₁₋ₙ performed by the job manager 4010 can fetch security information, including data source 6012₁₋ₙ configuration and/or credentials from the vault 6018. The vault 6018, for example, can store and maintain the relevant credentials and configurations required to fetch correct, up-to-date security information from data sources 6012₁₋ₙ, such as a SentinelOne cloud-based API, for example. Each fetch job 6010₁₋ₙ can query the respective data source 6012₁₋ₙ, and can send relevant security information to the queue 6008 for processing via the workflow engine 4012 (FIG. 4). The queue 6008 can be a highly scalable cluster configured to support and maintain each fetch job across all data sources 6012₁₋ₙ for each tenant 1010₁₋ₙ (FIG. 1). When the job manager 4010 launches a fetch job, it can be instantiated within the queue 6008, which can execute the fetch and output the fetched security information to the workflow engine 4012 (FIG. 4). The job manager 4010 can subsequently update a security status (e.g., record errors, timestamps, etc.) and can record any metrics (e.g., size, time to fetch, success/fail status, etc.) in the fetch job database 6006.

According to one non-limiting aspects, the queue 6008 can be configured to host Argo workflows, RabbitMQ can be used as a listener that triggers the jobs in the Argo workflows, Hashicorp Vault can be used as the vault 6018, PostGres database can be used as the fetch job database 6006, and Kubernetes can be used as the configuration manager 6004. However, it shall be appreciated that any comparable tools can be similarly configured to achieve similar results.

The workflow engine 4012 (FIG. 4) can enrich security information fetched upon executing each job in the queue 6008. As previously discussed, for each type passed by the job manager 4010, security information can be normalized to a common standard format and playbooks can be run to enrich the data with additional contextual data and/or metadata. Accordingly, the job manager 4010 and workflow engine 4012 (FIG. 4) can streamline investigations performed by SOC staff members. According to other non-limiting aspects, the workflow engine 4012 (FIG. 4) can be further configured to execute additional forms of enrichment, including graph-based linking of events and/or data types, and can further enrich security via threat intelligence feeds. For example, according to some non-limiting aspects, the workflow engine can be further configured to enrich data in various contexts. In other words, the workflow engine can execute a User and Entity Behavior Analytic (UEBA) process for all incoming artifacts and try to detect certain anomalies in behavior or device usage.

As previously discussed, the workflow engine 4012 (FIG. 4) can be further configured to automate response and synchronization back from the data sources 6012₁₋ₙ. For example, according to one non-limiting aspect, an alert can flow from a Splunk correlation and trigger a playbook within the workflow engine 4012 (FIG. 4) which can initiate a command back to the Splunk application and automatically run an additional series of searches to contextualize the initial alert.

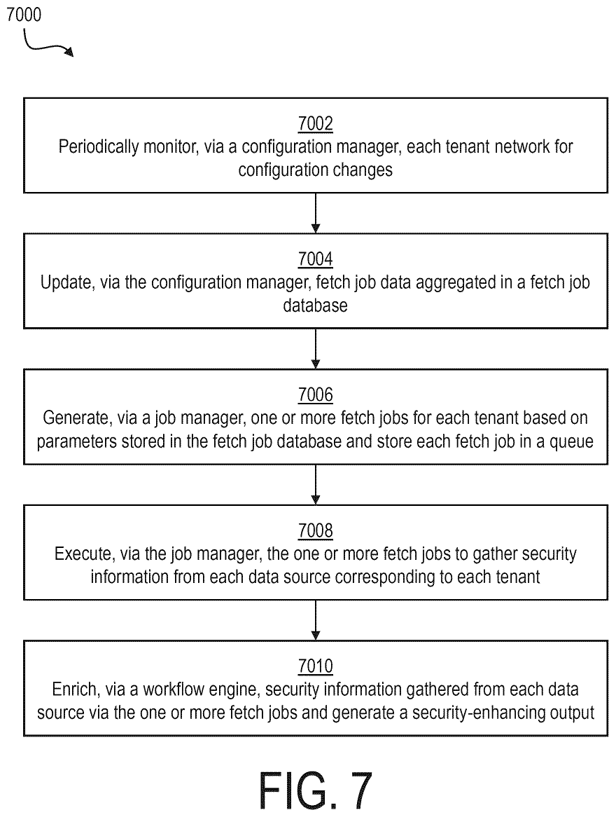

Referring now to FIG. 7, a method 7000 of ingesting and enriching a highly scalable quantity of security information is depicted in accordance with at least one non-limiting aspect of the present disclosure. According to the non-limiting aspect of FIG. 7, the method 7000 can be performed by a SIEM provider server 1002 (FIGS. 1 and 2) via the platform 4000 of FIG. 4. Specifically, the MSSP management system 2004 (FIG. 2) stored in the memory 1006 (FIG. 1) can cause a processor 1004 (FIG. 1) of the SIEM provider server 1002 (FIGS. 1 and 2) to perform the method 3000. With reference now to FIG. 6, in one aspect of the method 7000, the configuration manager 6004 (FIG. 6) can periodically monitor 7002 each tenant 1010₁₋ₙ network for configuration changes. The configuration manager 6004 (FIG. 6) can autonomously update 7004 fetch job data and aggregate it into a fetch job database 6006 (FIG. 6). The job manager 4010 (FIGS. 4 and 6) can then generate 7006 one or more fetch jobs to gather security information from data sources 6012₁₋ₙ (FIG. 6), wherein each data source 6012₁₋ₙ (FIG. 6) corresponds to at least one tenant 1010₁₋ₙ (FIG. 1). The job manager 4010 (FIGS. 4 and 6) can further store each fetch job in a queue 6008 (FIG. 6) and execute 7008 the one or more fetch jobs to gather security information from each data source 6012₁₋ₙ. A workflow engine 4012 (FIGS. 4 and 6) can then enrich the security information and generate an output which can be transmitted to a tenant security management system 4030 configured to disposition the output and enhance network security.

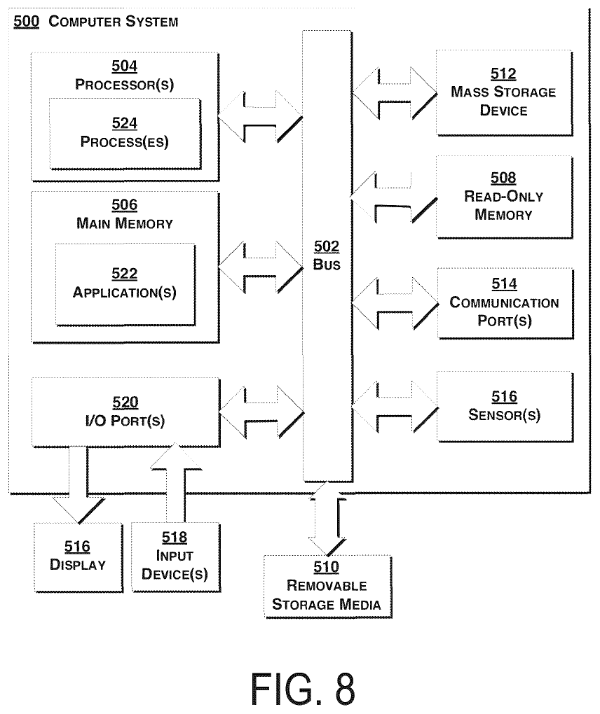

Referring now to FIG. 8, a scalable security information and event management framework computer system 500 is depicted, as originally described in U.S. Pat. No. 10,708, 123, titled SCALABLE SECURITY INFORMATION AND EVENT MANAGEMENT (SIEM) FRAMEWORK and filed Apr. 24, 2019, the disclosure of which is herein incorporated by reference in its entirety. Specifically, FIG. 8 depicts a schematic diagram of a computer system 500 upon which embodiments described in the present disclosure may be implemented and carried out. According to one non-limiting aspect the computer system 500 may include a bus 502 (i.e., interconnect), one or more processors 504, a main memory 506, read-only memory 508, removable storage media 510, mass storage 512, and one or more communications ports 514. As should be appreciated, components such as removable storage media are optional and are not necessary in all systems. Communication port 514 may be connected to one or more networks by way of which the computer system 500 may receive and/or transmit data. As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process. Processor(s) 504 can be any known processor, such as, but not limited to, processors manufactured by and/or sold by INTEL®, AMD®, or MOTOROLA®, and the like, that are generally well-known to one skilled in the relevant art and are well-defined in the literature. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used. Bus 502 communicatively couples processor(s) 504 with the other memory, storage, and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Accordingly, the job manager 4010 (FIGS. 4 and 6), workflow engine 4012 (FIG. 4), and method 7000 (FIG. 7) can be implemented via cloud-hosted technology configured to ingest and enrich data through automation at arbitrarily large scale. Collectively, the job manager 4010 (FIGS. 4 and 6) and workflow engine 4012 (FIG. 4) can ingest and enrich security information from any data source 6012₁₋ₙ type and can effectively and efficiently scale MSSP support for a single and/or large number “n” of tenants 1010₁₋ₙ (FIG. 1) and corresponding sources 6012₁₋ₙ, relative to convention devices, systems, and methods. Additionally, the devices, systems, and methods disclosed herein are vendor agnostic and can orchestrate efficient response actions (e.g., take any action on any tool within a client environment, provided the appropriate API is in place) regardless of whether the tenant 1010₁₋ₙ uses a custom or third part source 6012₁₋ₙ. Moreover, the job manager 4010 (FIGS. 4 and 6) and workflow engine 4012 (FIG. 4) can decouple data ingest and workflow orchestration and automation from ticketing and case management tools and processes. Finally, the job manager 4010 (FIGS. 4 and 6) and workflow engine 4012 (FIG. 4) can facilitate security information collection for extensible analytics use-cases (e.g., cross client case correlation and/or correlation of case data with external threat and vulnerability sets, large scale trend analysis and statistical analytic model analysis, etc).

Various aspects of the subject matter described herein are set out in the following numbered clauses:

Clause 1: A Security Information and Event Management (“SIEM”) provider server configured to enhance network security on behalf of a tenant network by autonomously ingesting and enriching security information associated with the tenant network, wherein the SIEM provider server includes a processor, and a memory, wherein the memory is configured to store a job manager and a workflow engine that, when executed by the processor, causes the processor to: periodically monitor, via a configuration manager of the job manager, the tenant network for configuration changes, detect, via the configuration manager, a configuration change in the tenant network, update, via the configuration manager, a fetch job parameter stored in a job database based on the detected configuration change in the tenant network, generate, via the job manager, a fetch job for the tenant network based on the updated job parameter stored in the job database and store the generated fetch job in a queue, execute, via the job manager, the generated fetch job such that the job manager retrieves security information from a data source associated with the tenant network, enrich, via the workflow engine, the retrieved security information, and generate, via the workflow engine, an output configured to enhance the security of the tenant network.

Clause 2: The SIEM provider server according to clause 1, wherein the tenant network is one of a plurality of tenant networks, wherein the tenant-specific SIEM implementation is one of a plurality of tenant-specific SIEM implementations generated by the SIEM provider server, and wherein the SIEM provider server is configured to simultaneously deploy and update each SIEM implementation of the plurality of SIEM implementations on behalf of each tenant network of the plurality of tenant networks.

Clause 3: The SIEM provider server according to clauses 1 or 2, wherein the SIEM provider server is communicably coupled to a tenant security management system configured to disposition outputs from the SIEM provider server, and wherein the method further includes transmitting, via the workflow engine, the output to the tenant security management system for dispositioning.

Clause 4: The SIEM provider server according to any of clauses 1-3, wherein dispositioning the output includes autonomously removing a suspect account from the tenant network.

Clause 5: The SIEM provider server according to any of clauses 1-4, wherein the workflow engine includes a plurality of modules, and wherein the plurality of modules includes an enrichment module, an indicator of compromise (“IOC”) extraction module, a normalization module, a security operations center (“SOC”) automation module, and a post-enrichment automation module.

Clause 6: The SIEM provider server according to any of clauses 1-5, wherein, when executed by the processor, the workflow engine further causes the processor to detect a type of security information associated with the retrieved security information, wherein enriching the retrieved security information includes enriching, via the enrichment module, the retrieved security information based on the detected type of security information.

Clause 7: The SIEM provider server according to any of clauses 1-6, wherein the detected type of security information is a security alert associated with the tenant network.

Clause 8: The SIEM provider server according to any of clauses 1-7, wherein, when executed by the processor, the workflow engine further causes the processor to identify, via the SOC automation module, an applicable automation playbook based on the detected type of security information, and wherein enriching, via the enrichment module, the retrieved security information is further based on the identified automation playbook.

Clause 9: The SIEM provider server according to any of clauses 1-8, further including transforming, via the normalization module, the retrieved security information into a standard format.

Clause 10: A method of enhancing network security on behalf of a tenant network by autonomously ingesting and enriching security information associated with the tenant network via a Security Information and Event Management (“SIEM”) provider server, wherein the SIEM provider server includes a processor and a memory configured to store a job manager and a workflow engine, the method including: periodically monitoring, via a configuration manager of the job manager, the tenant network for configuration changes, detecting, via the configuration manager, a configuration change in the tenant network, updating, via the configuration manager, a fetch job parameter stored in a job database based on the detected configuration change in the tenant network, generating, via the job manager, a fetch job for the tenant network based on the updated job parameter stored in the job database and store the generated fetch job in a queue, executing, via the job manager, the generated fetch job such that the job manager retrieves security information from a data source associated with the tenant network, enriching, via the workflow engine, the retrieved security information, and generating, via the workflow engine, an output configured to enhance the security of the tenant network.

Clause 11: The method according to clause 10, wherein the workflow engine includes a plurality of modules, and wherein the plurality of modules includes an enrichment module, an indicator of compromise (“IOC”) extraction module, a normalization module, a security operations center (“SOC”) automation module, and a post-enrichment automation module.

Clause 12: The method according to either of clauses 10 or 11, further including detecting, via the workflow engine, a type of security information associated with the retrieved security information, and wherein enriching the retrieved security information includes enriching, via the enrichment module, the retrieved security information based on the detected type of security information.

Clause 13: The method according to any of clauses 10-12, further including identifying, via the SOC automation module, an applicable automation playbook based on the detected type of security information, and wherein enriching, via the enrichment module, the retrieved security information is further based on the identified automation playbook.

Clause 14: The method according to any of clauses 10-13, further including transmitting, via the workflow engine, the output to the tenant security management system communicably coupled to the SIEM provider server for dispositioning.

Clause 15: The method according to any of clauses 10-14, wherein dispositioning the output includes autonomously removing a suspect account from the tenant network.

Clause 16: A system including a plurality of tenant networks, and a Security Information and Event Management (“SIEM”) provider server communicably coupled to the plurality of tenant networks, wherein the SIEM provider server includes a processor, and a memory configured to store a job manager and a workflow engine that, when executed by the processor, cause the processor to periodically monitor the plurality of tenant networks for configuration changes, detect a configuration change in a first tenant network of the plurality of tenant networks, update a fetch job parameter stored in a job database based on the detected configuration change in the first tenant network, generate a fetch job for the tenant network based on the updated fetch job parameter stored in the job database and store the generated fetch job in a queue, execute the generated fetch job such that the job manager retrieves security information from a data source associated with the tenant network, enrich the retrieved security information, and generate an output configured to enhance the security of the tenant network.

Clause 17: The system according to clause 16, wherein the SIEM provider server is communicably coupled to a tenant security management system configured to disposition outputs from the SIEM provider server, and wherein, when executed by the processor, the job manager and the workflow engine that, further cause the processor to transmit, via the workflow engine, the output to the tenant security management system for dispositioning.

Clause 18: The system according to either of clauses 16 or 17, wherein dispositioning the output includes autonomously removing a suspect account from the tenant network.

Clause 19: The system according to any of clauses 16-18, wherein the workflow engine includes a plurality of modules, and wherein the plurality of modules includes an enrichment module, an indicator of compromise (“IOC”) extraction module, a normalization module, a security operations center (“SOC”) automation module, and a post-enrichment automation module.

Clause 20: The system according to any of clauses 16-19, wherein the detected type of security information is a security alert associated with the tenant network.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

1. A Security Information and Event Management (“SIEM”) provider server configured to enhance network security on behalf of a tenant network by autonomously ingesting and enriching security information associated with the tenant network, wherein the SIEM provider server comprises a processor, and a memory configured to store a job manager and a workflow engine that, when executed by the processor, cause the processor to:
periodically monitor, via a configuration manager of the job manager, the tenant network for configuration changes;
detect, via the configuration manager, a configuration change in the tenant network;
update, via the configuration manager, a fetch job parameter stored in a job database based on the detected configuration change in the tenant network;
generate, via the job manager, a fetch job for the tenant network based on the updated fetch job parameter stored in the job database and store the generated fetch job in a queue;
execute, via the job manager, the generated fetch job such that the job manager retrieves security information from a data source associated with the tenant network;
enrich, via the workflow engine, the retrieved security information; and
generate, via the workflow engine, an output configured to enhance the security of the tenant network.

2. The SIEM provider server of claim 1, wherein the tenant network is one of a plurality of tenant networks, and wherein the SIEM provider server is configured to simultaneously monitor each tenant network of the plurality of tenant networks for configuration changes

3. The SIEM provider server of claim 1, wherein the SIEM provider server is communicably coupled to a tenant security management system configured to disposition outputs from the SIEM provider server, and wherein, when executed by the processor, the job manager and the workflow engine that, further cause the processor to transmit, via the workflow engine, the output to the tenant security management system for dispositioning.

4. The SIEM provider server of claim 3, wherein dispositioning the output comprises autonomously removing a suspect account from the tenant network.

5. The SIEM provider server of claim 1, wherein the workflow engine comprises a plurality of modules, and wherein the plurality of modules comprises an enrichment module, an indicator of compromise (“IOC”) extraction module, a normalization module, a security operations center (“SOC”) automation module, and a post-enrichment automation module.

6. The SIEM provider server of claim 5, wherein, when executed by the processor, the workflow engine further causes the processor to detect a type of security information associated with the retrieved security information, wherein enriching the retrieved security information comprises enriching, via the enrichment module, the retrieved security information based on the detected type of security information.

7. The SIEM provider server of claim 6, wherein the detected type of security information is a security alert associated with the tenant network.

8. The SIEM provider server of claim 6, wherein, when executed by the processor, the workflow engine further causes the processor to identify, via the SOC automation module, an applicable automation playbook based on the detected type of security information, and wherein enriching, via the enrichment module, the retrieved security information is further based on the identified automation playbook.

9. The SIEM provider server of claim 5, further comprising transforming, via the normalization module, the retrieved security information into a standard format.

10. A method of enhancing network security on behalf of a tenant network by autonomously ingesting and enriching security information associated with the tenant network via a Security Information and Event Management (“SIEM”) provider server, wherein the SIEM provider server comprises a processor and a memory configured to store a job manager and a workflow engine, the method comprising:
periodically monitoring, via a configuration manager of the job manager, the tenant network for configuration changes;
detecting, via the configuration manager, a configuration change in the tenant network;
updating, via the configuration manager, a fetch job parameter stored in a job database based on the detected configuration change in the tenant network;
generating, via the job manager, a fetch job for the tenant network based on the updated fetch job parameter stored in the job database and store the generated fetch job in a queue;
executing, via the job manager, the generated fetch job such that the job manager retrieves security information from a data source associated with the tenant network;
enriching, via the workflow engine, the retrieved security information; and
generating, via the workflow engine, an output configured to enhance the security of the tenant network.

11. The method of claim 10, wherein the workflow engine comprises a plurality of modules, and wherein the plurality of modules comprises an enrichment module, an indicator of compromise (“IOC”) extraction module, a normalization module, a security operations center (“SOC”) automation module, and a post-enrichment automation module.

12. The method of claim 11, further comprising detecting, via the workflow engine, a type of security information associated with the retrieved security information, and wherein enriching the retrieved security information comprises enriching, via the enrichment module, the retrieved security information based on the detected type of security information.

13. The method of claim 11, further comprising identifying, via the SOC automation module, an applicable automation playbook based on the detected type of security information, and wherein enriching, via the enrichment module, the retrieved security information is further based on the identified automation playbook.

14. The method of claim 10, further comprising transmitting, via the workflow engine, the output to a tenant security management system communicably coupled to the SIEM provider server for dispositioning.

15. The method of claim 14, wherein dispositioning the output comprises autonomously removing a suspect account from the tenant network.

16. A system comprising:
a plurality of tenant networks; and
a Security Information and Event Management (“SIEM”) provider server communicably coupled to the plurality of tenant networks, wherein the SIEM provider server comprises a processor, and a memory configured to store a job manager and a workflow engine that, when executed by the processor, cause the processor to:
periodically monitor the plurality of tenant networks for configuration changes;
detect a configuration change in a first tenant network of the plurality of tenant networks;
update a fetch job parameter stored in a job database based on the detected configuration change in the first tenant network;
generate a fetch job for the tenant network based on the updated fetch job parameter stored in the job database and store the generated fetch job in a queue;
execute the generated fetch job such that the job manager retrieves security information from a data source associated with the tenant network;
enrich the retrieved security information; and
generate an output configured to enhance the security of the tenant network.

17. The system of claim 16, wherein the SIEM provider server is communicably coupled to a tenant security management system configured to disposition outputs from the SIEM provider server, and wherein, when executed by the processor, the job manager and the workflow engine that, further cause the processor to transmit, via the workflow engine, the output to the tenant security management system for dispositioning.

18. The system of claim 17, wherein dispositioning the output comprises autonomously removing a suspect account from the tenant network.

19. The system of claim 16, wherein the workflow engine comprises a plurality of modules, and wherein the plurality of modules comprises an enrichment module, an indicator of compromise (“IOC”) extraction module, a normalization module, a security operations center (“SOC”) automation module, and a post-enrichment automation module.

20. The SIEM provider server of claim 19, wherein the detected type of security information is a security alert associated with the tenant network.
